(19) United States
(12) Patent Application Publication
(10) Pub. No.: US 2004/0042957 A1
(43) Pub. Date: Mar. 4, 2004

(54) Method and apparatus for providing pressurized hydrogen gas

(76) Inventor: David Martin, Toronto (CA)

Correspondence Address: HODGSON RUSS LLP, ONE M & T PLAZA, SUITE 2000, BUFFALO, NY, 14203-2391, US

(21) Appl. No.: 10/239,686

(22) PCT Filed: Mar. 16, 2001
(86) PCT No.: PCT/CA01/00351

(30) Foreign Application Priority Data
Mar. 17, 2000 (CA) 2,300,770

(51) Int. Cl. C01B 6/24

(52) U.S. Cl. 423/644

(57) ABSTRACT

Apparatus and process for producing hydrogen gas at a desired pressure comprising feeding a hydrogen gas at a first temperature and first pressure from a hydrogen source to heat transfer means comprising cooling means and heating means; cooling the hydrogen gas with the cooling means to provide cooled hydrogen gas; feeding the cooled hydrogen gas to a metal hydride generator containing the metal; forming the metal hydride within the generator; heating the formed metal hydride to a temperature Tp and desired pressure; and releasing the pressurized hydrogen gas at the desired pressure from the generator and producing regenerated metal. Preferably, the apparatus comprises a plurality of generators linked to the heat transfer means to allow for continuous usage of both cooled hydrogen gas and generated heat from the heat transfer means to collectively provide a continuous pressurized hydrogen gas product

### FIELD OF THE INVENTION

This invention relates to the production of hydrogen gas at a desired pressure, particularly hydrogen gas produced by an electrolyser or methanol reformer, and more particularly in a continuous manner.

### BACKGROUND TO THE INVENTION

An electrochemical cell is used for electrochemical reactions and comprises anode and cathode electrodes immersed in an electrolyte with the current passed between the electrodes from an external power source. The rate of production is proportional to the current flow in the absence of parasitic reactions. For example, in a liquid alkaline water electrolysis cell, the DC current is passed between the two electrodes in an aqueous electrolyte to split water, the reactant, into component product gases, namely, hydrogen and oxygen where the product gases evolve at the surfaces of the respective electrodes.

Hydrogen generating units, sometimes called “thermal compressors”, are known, for example in U.S. Pat. No. 4,402,187 (1983) and U.S. Pat. No. 4,505,120 (1985), which utilize reversible metal hydrides. These metal alloys possess the ability to absorb large volumes of hydrogen gas at room temperature and because the pressure/temperature relationship is exponential, large pressure increases can be created with only moderate temperature increases. In a thermal compressor, hydrogen is absorbed at low pressure and temperature, typically, in a water-cooled hydride container, which is subsequently heated with hot water and hydrogen is then released at higher pressure. To obtain even higher pressures, several stages of compression may be connected in series, each stage using a different hydride alloy selected for its higher operating pressure at the operating temperature.

Thermoelectric modules are small, solid state, heat pumps that cool, heat and generate power. In function, they are similar to conventional refrigerators in that they move heat from one area to another and, thus, create a temperature differential.

A thermoelectric module is comprised of an array of semiconductor couples (P and N pellets) connected electrically in series and thermally in parallel, sandwiched between metallized ceramic substrates. In essence, if a thermoelectric module is connected to a DC power source, heat is absorbed at one end of the device to cool that end, while heat is rejected at the other end, where the temperature rises. This is known as the Peltier Effect. By reversing the current flow, the direction of the heat flow is reversed.

It is known that a thermoelectric element (TEE) or module may function as a heat pump that performs the same cooling function as Freon-based vapor compression or absorption refrigerators. The main difference between a TEE device and the conventional vapor-cycle device is that thermoelectric elements are totally solid state, while vapor-cycle devices include moving mechanical parts and require a working fluid. Also, unlike conventional vapor compressor systems, thermoelectric modules are, most generally, miniature devices. A typical module measures 2.5 cm×2.5 cm×4 mm, while the smallest sub-miniature modules may measure 3 mm×3 mm×2 mm. These small units are capable of reducing the temperature to well-below water-freezing temperatures.

Thermoelectric devices are very effective when system design criteria requires specific factors, such as high reliability, small size or capacity, low cost, low weight, intrinsic safety for hazardous electrical environments, and precise temperature control. Further, these devices are capable of refrigerating a solid or fluid object.

A bismuth telluride thermoelectric element consists of a quaternary alloy of bismuth, tellurium, selenium and antimony—doped and processed to yield oriented polycrystalline semiconductors with anisotropic thermoelectric properties. The bismuth telluride is primarily used as a semiconductor material, heavily doped to create either an excess (n-type) or a deficiency (p-type) of electrons. A plurality of these couples are connected in series electrically and in parallel thermally, and integrated into modules. The modules are packaged between metallized ceramic plates to afford optimum electrical insulation and thermal conduction with high mechanical compression strength. Typical modules contain from 3 to 127 thermocouples. Modules can also be mounted in parallel to increase the heat transfer effect or stacked in multistage cascades to achieve high differential temperatures.

These TEE devices became of practical importance only recently with the new developments of semiconductor thermocouple materials. The practical application of such modules required the development of semiconductors that are good conductors of electricity, but poor conductors of heat to provide the perfect balance for TEE performance. During operation, when an applied DC current flows through the couple, this causes heat to be transferred from one side of the TEE to the other; and, thus, creating a cold heat sink side and hot heat sink side. If the current is reversed, the heat is moved in the opposite direction. A single-stage TEE can achieve temperature differences of up to 70° C., or can transfer heat at a rate of 125 W. To achieve greater temperature differences, i.e up to 13 1° C., a multistage, cascaded TEE may be utilized.

A typical application exposes the cold side of the TEE to the object or substance to be cooled and the hot side to a heat sink, which dissipates the heat to the environment. A heat exchanger with forced air or liquid may be required.

### SUMMARY OF THE INVENTION

It is an object of the present invention to provide apparatus and process for the production of hydrogen gas at a desired pressure.

Accordingly, in one aspect the invention provides a process for producing hydrogen gas at a desired pressure, said process comprising feeding a hydrogen gas at a first temperature and first pressure from a hydrogen source to heat transfer means comprising cooling means and heating means; cooling said hydrogen gas with said cooling means to provide cooled hydrogen gas; feeding said cooled hydrogen gas to a metal hydride generation means containing said metal; forming said metal hydride within said generation means; heating said formed metal hydride to a temperature Tp and desired pressure; and releasing said pressurized hydrogen gas at said desired pressure from said generation means and producing regenerated said metal.

The metal hydrides of use in the present invention are examples of materials collectively termed “hydridable material”.

The term metal hydride generator as used in this specification includes “thermal hydrogen compressors” as described, for example, in U.S. Pat. No. 4,402,187 and U.S. Pat. No. 4,505,120 and other publications.

Most preferably, the heat generated in the heat transfer means is used to heat the metal hydride generator when it contains the metal hydride made from the metal and hydrogen, in order to provide released hydrogen under the desired pressure. A preferred heat transfer means is a “Peltier” thermoelectric module which operably provides a cooling surface for cooling the source hydrogen and concomitantly heating surface which is used to heat a transfer liquid, such as, for example, water and/or steam.

In those cases where the source hydrogen contains moisture and/or other condensable components, such as from a water electrolyser or methanol reformer these components are preferably condensed out at the cooling surface of the thermoelectric module, and removed.

I have found that feeding the cooled hydrogen gas to the metal hydride generator while the metal per se is still well above ambient temperature after releasing pressurized hydrogen gas product, increases the rate of cooling of the metal and, thus, turnaround, in the regeneration of metal hydride.

Further, to favour thermal balances within the full process and enhance the rate of heating of the generator to the desired temperature and pressure of the metal hydride generator to effect pressurized hydrogen release, heat produced in the hydrogen source generation process, may be transferred to the generator at the appropriate time.

In a most preferred process according to the invention, the process utilizes a plurality of metal hydride generators suitably linked by hydrogen gas transfer conduits and heat transfer conduits to the hydrogen source, heat transfer means and metal hydride generators.

Accordingly, in a farther aspect the invention provides a process as hereinabove defined further comprising providing a plurality of said metal hydride generation means; feeding suitable portions of said cooled hydrogen gas to said plurality of said metal hydride generation means in a selective manner to effect continuous, effective utilization of said cooled hydrogen gas produced at said cooling means and respective production of said metal hydride.

In a yet further aspect the invention further comprises generating heat in said heating means and transferring suitable portions of said generated heat to said plurality of said generation means in a selective manner to effect continuous utilization of said generated heat to effect respective release of said pressurized hydrogen gas, therefrom.

In a further aspect, the invention provides apparatus for producing pressurized hydrogen gas at a desired pressure, comprising means for providing a hydrogen gas; heat transfer means comprising cooling means and heating means; means for feeding said hydrogen gas to said cooling means to produce a cooled hydrogen gas; metal hydride generation means comprising said metal; means for feeding said cooled hydrogen gas to said generation means; means for heating said generation means; and means for releasing said pressurized hydrogen gas from said generation means.

In a yet further aspect, the invention provides apparatus as hereinbefore defined further comprising a plurality of said metal hydride generation means and means for feeding said cooled hydrogen gas to said plurality of generation means in a selective manner to effect continuous, effective utilization of said cooled hydrogen produced at said cooling means and respective synchronous production of said metal hydride.

In a most preferred aspect, the invention provides a central processing unit (CPU), suitably linked to thermometers, pressure gauges, valves and adjustment and timing units to enable the process, once at steady state, to be continuously self-monitoring and continuously providing hydrogen gas at a desired selected pressure for subsequent real-time use or storage.

Accordingly in a further aspect, the invention provides a process as hereinbefore defined further comprising measuring, controlling and adjusting process temperatures, pressures and hydrogen gas flow rates parameters, and subjecting said parameters to algorithmic treatment to enable said process to be continually self-monitoring.

In yet a further aspect, the invention provides apparatus as hereinbefore defined further comprising process control means to measure, control and adjust process parameters.

The process control means may comprise

a. computer algorithmic microprocessor means; and

b. temperature and pressure sensor and control means, hydrogen gas flow rate measurement, adjustment and control means.

The algorithmic means enables the process to be continuously self-monitoring, preferably when a steady-state of hydrogen gas output for, immediate, subsequent use in real-time or storage has been reached.

### BRIEF DESCRIPTION ON THE DRAWINGS

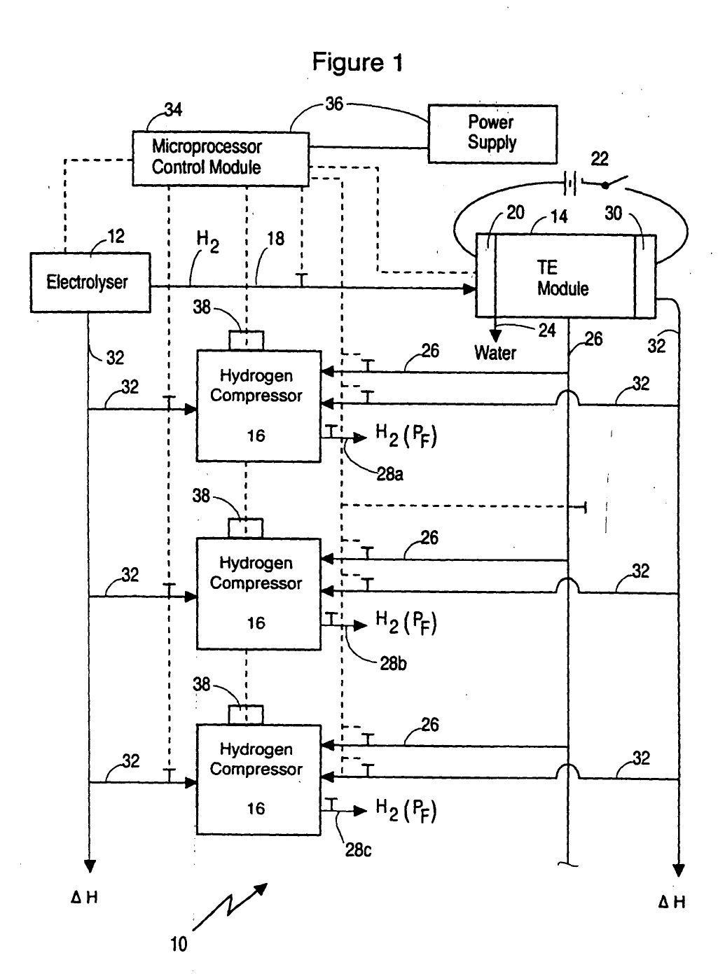

In order that the invention may be better understood, a preferred embodiment will now be described by way of example only with reference to the accompanying drawing wherein FIG. 1 is a block diagram of the apparatus and process according to the invention.

### DETAILED DESCRIPTION OF A PREFERRED EMBODIMENT

FIG. 1 shows generally as 10 apparatus and process for the production of purified hydrogen at a desired pressure P_{F} comprising a hydrogen source 12 and thermoelectric module heat transfer unit 14 linked through suitable conduits as hereinafter described to each of a plurality of metal hydride generators (hydrogen compressors) 16 (three in the embodiment shown). Hydrogen source 12 is preferably a water electrolyser which generates hydrogen gas, typically, at positive pressure, for example, up to 100 psi. The hydrogen when produced is wet and contains caustic and oxygen impurities. Hydrogen is passed through conduit 18 to the cooling surface 20 of thermoelectric module 14 activated by a DC source 22. At surface 20, water contained in the gas is condensed and run-off through conduit 24.

Compressors 16 contain a metal, such as nickel in the form of powder, suitable to react with hydrogen to form metal hydride.

Cooled hydrogen gas from module surface 20 is sent through conduit 26 to each of units 16a, 16b, 16c, etc. in a suitable selective manner to utilize the continuously produced cooled hydrogen. For example, when reactor 16a is hot and pressurized, hydrogen therefrom is controllably released through conduit 28a as the desired product at pressure P_{F} and subsequently in a timely fashion out of 28b, 28c, etc. Since this stage does not require cooled hydrogen addition, the latter, from the module is used to fill 16b or 16c, etc. as appropriate in their respective cycles.

Once metal has been regenerated in 16a, and pressurized hydrogen removed, the cold hydrogen is preferably added to 16a to enhance the rate of cooling of the metal while the metal is still hot, and the cycle is repeated.

In an analogous manner, heat generated at the ‘hot’ end 30 of module 14 is transferred through water/steam conduits 32 at the appropriate stage of each unit 16a, 16b, 16c, etc. cycle, to selectively raise, in turn, the temperature of each unit 16a, 16b, 16c, etc. in order to continuously, efficiently, effectively utilize the heat generated at module end 30.

In a further analogous manner, any surplus heat produced at electrolyser hydrogen source 12 may, likewise, stepwise, selectively be utilized to reinforce the heat provided by module end 30 to units 16a, 16b, 16c, etc., through conduit 32.

The continuous self-monitoring aspect of the apparatus and process results from the use of an algorithmical software-loaded microprocessor control module 34 electronically linked as shown by the dotted lines to electrolyser 12, Peltier thermoelectric module 14, temperature and pressure monitors contained within units 38 and electrically-controlled control valves 40. Power is supplied by supply 36.

Thus, the aforesaid embodiment provides a method and apparatus for producing pressurized hydrogen at a desired pressure in a continuous manner by means of a plurality of hydrogen compressors operating in stepwise fashion in association with a thermoelectric module and electrolyser. Accordingly, favourable heat transfers and thermal main balances can be suitably effected.

In alternative embodiments, a methanol reformer or other hydrogen generating process may be used to provide the hydrogen gas to be satisfactorily pressurized.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. A process for producing hydrogen gas at a desired pressure, said process comprising:
(i) feeding a hydrogen gas at a first temperature and first pressure from a hydrogen source to heat transfer means comprising cooling means and heating means;
(ii) cooling said hydrogen gas with said cooling means to provide cooled hydrogen gas;
(iii) feeding said cooled hydrogen gas to a metal hydride generation means containing said metal;
(iv) forming said metal hydride within said generation means;
(v) heating said formed metal hydride to a temperature Tp and desired pressure; and
(vi) releasing said pressurizied hydrogen gas at said desired pressure from said generation means and producing regenerated said metal.

2. A process as defined in claim 1 comprising generating heat in said heating means and transferring said generated heat to heat said formed metal hydride in step (v).

3. A process as defined in claim 1 or claim 2 wherein said heat transfer means comprises a thermoelectric Peltier module.

4. A process as defined in any one of claims 1 to 3 comprising cooling said regenerated metal with said cooled hydrogen gas.

5. A process as defined in any one of claims 1 to 4 wherein said first hydrogen gas contains water, said process further comprising condensing said water at said cooling means, and removing said condensed water.

6. A process as defined in any one of claims 1 to 5 comprising providing said hydrogen gas from an electrolyser source.

7. A process as defined in any on one of claims 1 to 6 wherein heat is produced in said hydrogen source, and comprising transferring said heat, in whole or in part, to heat said formed metal hydride.

8. A process as defined in any one of claims 1 to 7 further comprising providing a plurality of said metal hydride generation means;
feeding suitable portions of said cooled hydrogen gas to said plurality of said metal hydride generation means in a selective manner to effect continuous, effective utilization of said cooled hydrogen gas produced at said cooling means and respective production of said metal hydride.

9. A process as defined in claim 8 further comprising generating heat in said heating means and transferring suitable portions of said generated heat to said plurality of said generation means in a selective manner to effect continuous utilization of said generated heat to effect respective release of said pressurized hydrogen gas, therefrom.

10. A process as defined in claim 8 or claim 9 further comprising measuring, controlling and adjusting process temperatures, pressures and hydrogen gas flow rates parameters, and subjecting said parameters to algorithmic treatment to enable said process to be continually self-monitoring.

11. Apparatus for producing pressurized hydrogen gas at a desired pressure, comprising:
(i) means for providing a hydrogen gas;
(ii) heat transfer means comprising cooling means and heating means;
(iii) means for feeding said hydrogen gas to said cooling means to produce a cooled hydrogen gas;
(iv) metal hydride generation means comprising said metal;
(v) means for feeding said cooled hydrogen gas to said generation means;
(vi) means for heating said generation means; and
(vii) means for releasing said pressurized hydrogen gas from said generation means.

12. Apparatus as defined in claim 11 wherein means for heating said generation means (vi) comprises said heating means denoted in (ii).

13. Apparatus as defined in claim 11 or claim 12 wherein said heat transfer means (ii) comprises a thermoelectric Peltier module.

14. Apparatus as defined in any one of claims 11 to 13 further comprises means for condensing water contained in said first hydrogen gas.

15. Apparatus as defined in any one of claims 11 to 14 comprising hydrogen generation means selected from an electrolyser and methanol reformer.

16. Apparatus as defined in any one of claims 11 to 15 further comprising a plurality of said metal hydride generation means and means for feeding said cooled hydrogen gas to said plurality of generation means in a selective manner to effect continuous, effective utilization of said cooled hydrogen produced at said cooling means and respective synchronous production of said metal hydride.

17. Apparatus as defined in claim 16 further comprising means for transferring suitable portions of said plurality of said generated heat of said means to said generation means in a selective manner to effect continuous utilization of said generated heat to effect respective synchronous release of said pressurized hydrogen gas, therefrom.

18. Apparatus as defined in any one of claims 11 to 17 further comprising process control means to measure, control and adjust process parameters.

19. Apparatus as defined in claim 18 wherein said process control means comprises
(i) computer algorithmic microprocessor means; and
(ii) temperature and pressure sensor and control means, hydrogen gas flow rate measurement, adjustment and control means.

20. Apparatus as defined in claim 19 wherein said algorithmic means enables the process to be continuously self-monitoring.
